(19) United States
(12) Patent Application Publication
(10) Pub. No.: US 2026/0309314 A1
(43) Pub. Date: Oct. 8, 2026

(54) Electronic Paper Display

(71) Applicant: Hanshow Technology Co., Ltd., Jiaxing, Zhejiang (CN)

(72) Inventors: Yanchen LI, Jiaxing, Zhejiang (CN); Zhaoyun WU, Jiaxing, Zhejiang (CN); Xiang TIAN, Jiaxing, Zhejiang (CN); Jianguo ZHAO, Jiaxing, Zhejiang (CN); Shiguo HOU, Jiaxing, Zhejiang (CN)

(21) Appl. No.: 19/483,364

(22) PCT Filed: May 11, 2024
(86) PCT No.: PCT/CN2024/092516

§ 371 Date: Nov. 11, 2025

(30) Foreign Application Priority Data
May 12, 2023 (CN) 202321175093.2

(51) Int. Cl. F21V 19/00; F21W 111/00; G09F 3/20

(52) U.S. Cl. CPC F21V 19/003; G09F 3/208; F21W 2111/00

(57) ABSTRACT

An electronic paper display includes: a control printed circuit board, a thin film transistor substrate, a flexible printed circuit board, an integrated circuit and a Light Emitting Diode light. The PCB is located on a back side of the TFT substrate, and the FPC connects the PCB and the TFT substrate. The IC is connected on the front side of the TFT substrate in a non-display area; and the LED light is connected to a metal pad on the front side of the TFT substrate. The metal pad is located in an area within a front bonding zone of the TFT substrate and outside the IC and the FPC, and the LED light is connected to one or any combination of the IC, the FPC and the PCB through a metal wiring on the TFT substrate.

### RELATED APPLICATION

The present disclosure claims priority to Chinese Utility Model Application NO. 202321175093.2, filed on May 12, 2023, which is herein incorporated by reference in its entirety.

### TECHNICAL FIELD

The present disclosure relates to the technical field of a display screen of an electronic shelf label, and particularly to an electronic paper display.

### BACKGROUND

This section is intended to provide a background or context for embodiments of the present disclosure set forth in the claims. The description here is not admitted to be the prior art just because it is included in this section.

At present, the electronic shelf label with the electronic paper display is increasingly used in various shopping scenarios. In the prior art, in an electronic paper display module of an electronic shelf label, a Light Emitting Diode (LED) light mainly serves as an indicator for status display, position reminder, etc. FIG. 1 illustrates a plan view of an electronic paper display module of an electronic shelf label, in which (a) of FIG. 1 is a front plan view, where a Thin Film Transistor (TFT) substrate is on top and a Printed Circuit Board (PCB) is at bottom; and (b) of FIG. 1 is a rear plan view, where a PCB is on top and a TFT substrate is at bottom. FIG. 2 illustrates a cross-sectional view of an electronic paper display module of an electronic shelf label.

As can be seen from FIGS. 1 and 2, in an electronic paper display module of an existing electronic shelf label, an LED light is disposed on a PCB to realize a flashing reminder function. However, the existing electronic paper display module has poor light transmittance within the area of a TFT substrate. In order to allow light to be transmitted through efficiently, the LED light should be disposed outside the area of the TFT substrate, such as the positions illustrated in FIGS. 1 and 2. Since the size and the position of the PCB are constrained by the LED light, the bezel size of an electronic paper display for the electronic shelf label is increased. The increase in size results in resource waste and raises the cost of the electronic paper display for the electronic shelf label.

Embodiments of the present disclosure provide an electronic paper display, which is configured to remove constraints imposed by an LED light on a PCB, flexibly set the size of the PCB in the electronic paper display for an electronic shelf label based on actual requirements, and reduce the cost of the electronic paper display for the electronic shelf label. The electronic paper display is applied to a display screen for the electronic shelf label, the electronic paper display including: a control printed circuit board (PCB), a thin film transistor (TFT) substrate, a flexible printed circuit (FPC) board, an integrated circuit (IC) and a Light Emitting Diode (LED) light;
and the PCB is located on a back side of the TFT substrate, and the FPC connects the PCB and the TFT substrate;
the IC is connected on the front side of the TFT substrate in a non-display area; and
the LED light is connected to a metal pad on the front side of the TFT substrate, the metal pad is located in an area within a front bonding zone of the TFT substrate and outside the IC and the FPC, and the LED light is connected to one or any combination of the IC, the FPC and the PCB through a metal wiring on the TFT substrate.

The embodiments of the present disclosure provide an electronic paper display, which is applied to a display screen for the electronic shelf label, the electronic paper display including: a control printed circuit board (PCB), a thin film transistor (TFT) substrate, a flexible printed circuit (FPC) board, an integrated circuit (IC) and a Light Emitting Diode (LED) light; and the LED light is connected to a metal pad on a front side of the TFT substrate, the metal pad is located in an area within a front bonding zone of the TFT substrate and outside the IC and the FPC, and the LED light is connected to one or any combination of the IC, the FPC and the PCB through a metal wiring on the TFT substrate. Since the LED light is disposed on the TFT substrate, it is possible to flexibly set the size of the PCB based on requirements in practical applications, and eliminate the constraints imposed by the LED light on the PCB, thereby saving more space for the electronic paper display and reducing the cost of the electronic paper display for the electronic shelf label.

### BRIEF DESCRIPTION OF DRAWINGS

In order to more clearly illustrate the technical solutions in the embodiments of the present disclosure or in the prior art, the drawings to be used in the description of the embodiments or the prior art will be briefly introduced below. Obviously, the drawings involved in the following description only illustrate some embodiments of the present disclosure, and other drawings can be obtained by persons of ordinary skill in the art according to these drawings without paying any inventive effort. In the drawings:

FIG. 1 illustrates a plan view of an electronic paper display module of an existing electronic shelf label;

FIG. 2 illustrates a longitudinal structural diagram of an electronic paper display module of an existing electronic shelf label in FIG. 1;

FIG. 3 illustrates a plan view of an electronic paper display according to an embodiment of the present disclosure;

FIG. 4 illustrates a cross-sectional view of an electronic paper display in FIG. 3 according to an embodiment of the present disclosure;

FIG. 5 illustrates an implementation of an electronic paper display according to an embodiment of the present disclosure;

FIG. 6 illustrates an implementation of an electronic paper display according to an embodiment of the present disclosure; and

FIG. 7 illustrates an implementation of an electronic paper display according to an embodiment of the present disclosure.

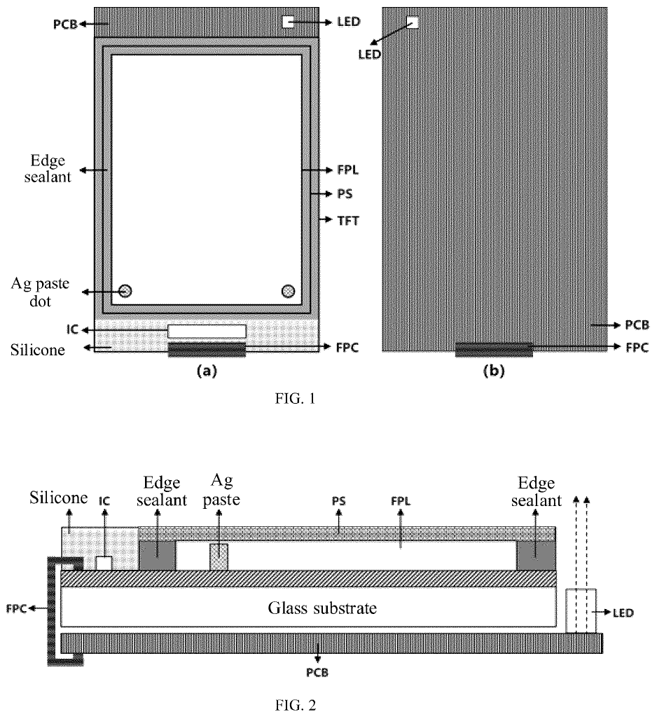

### DESCRIPTION OF EMBODIMENTS

In order that the objectives, technical solutions and advantages of the embodiments of the present disclosure are clearer, the embodiments of the present disclosure will be further described in detail with reference to the drawings. Here, the embodiments of present disclosure and the descriptions thereof are used to illustrate the present disclosure, but should not be used as limitations thereto.

The applicant has found that the existing electronic paper display module exhibits poor light transmittance within the area of a Thin Film Transistor (TFT) substrate. To enable efficient light transmission, a Light Emitting Diode (LED) light should be disposed outside the area of the TFT substrate. Since the size and the position of a Printed Circuit Board (PCB) are constrained by the LED light, the bezel size of an electronic paper display of an electronic shelf label increases. The increased size causes the waste of resources and increases the cost of the electronic paper display for the electronic shelf label. On this basis, the applicant proposes an electronic paper display for use in a display screen of an electronic shelf label.

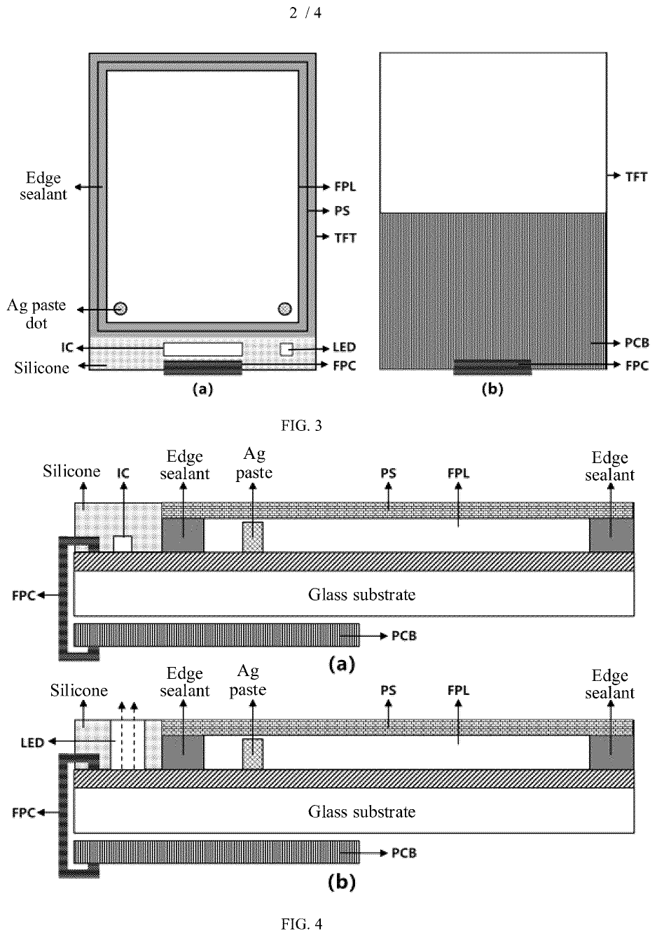

FIG. 3 illustrates a plan view of an electronic paper display according to an embodiment of the present disclosure, in which (a) of FIG. 3 is a front plan view, where a TFT substrate is on top and a PCB is at bottom; and (b) of FIG. 3 is a rear plan view, where a PCB is on top and a TFT substrate is at bottom. FIG. 4 illustrates a cross-sectional view of an electronic paper display in FIG. 3 according to an embodiment of the present disclosure, in which (a) of FIG. 4 is a cross-sectional view of a non-LED light area, and (b) of FIG. 4 is a cross-sectional view of an LED light area. FIGS. 3 and 4 illustrate an electronic paper display for the electronic shelf label display, the electronic paper display including: a printed circuit board (PCB), a thin film transistor (TFT) substrate, a Flexible Printed Circuit (FPC), an Integrated Circuit (IC), and a Light Emitting Diode (LED) light.

In this embodiment, the PCB is located on a back side of the TFT substrate, and the FPC connects the PCB and the TFT substrate;
the IC is connected on the front side of the TFT substrate in a non-display area; and
the LED light is connected to a metal pad on the front side of the TFT substrate, the metal pad is located in an area within a front bonding zone of the TFT substrate and outside the IC and the FPC, and the LED light is connected to one or any combination of the IC, the FPC and the PCB through a metal wiring on the TFT substrate.

The structure of the electronic paper display in FIG. 3 is specifically illustrated as follows. FIG. 3 mainly includes the following parts.

The PCB, as an external control circuit, provides a power supply, a control timing, a data signal, etc. to the electronic paper display. The PCB is located on the back side of the TFT substrate, and the size of the PCB may be flexibly set based on requirements in practical applications. For example, in FIG. 3, the size of the PCB is less than that of the TFT substrate, so as to reduce the cost of the electronic paper display for the electronic shelf label. The size relationship between the PCB and the TFT substrate is not limited in the embodiments of the present disclosure, and persons skilled in the art can flexibly set the size of the PCB. For instance, other components besides the LED light may also be added to the PCB, thereby enabling the addition of other functions based on the original size of the electronic paper display.

The TFT substrate, through processes such as film deposition, exposure, development, and etching, forms a pixel array and a driving circuit on a glass substrate to achieve driving and control of a TFT array. Taking 5-mask process (a photolithography process using five masks) as an example, the TFT substrate includes film layers such as Gate, Gate Insulator (GI), Active, Source/Drain (SD), Passivation (PV) and Indium-tin-oxide (ITO) from bottom to top. Gate and SD are metal film layers, usually made of opaque conductive metals such as Al, Mo, Nd, and Cu. GI and PV are insulating dielectric layers, usually composed of non-conductive insulating layers with good light transmittance such as SiO2 and SiNx. Active is an active semiconductor layer, usually made of semiconductor materials such as Amorphous Silicon (a-Si), Polycrystalline Silicon (p-Si) and Indium Gallium Zinc Oxide (IGZO). ITO is a transparent conductive metal oxide.

The IC, which is connected on the front side of the TFT substrate in the non-display area, and receives signals transmitted from an external circuit through the FPC, and converts the signals into voltages and timings that drive the electronic paper display to refresh.

The FPC, which is configured to connect the external PCB circuit and the electronic paper display, so as to realize signal transmission between the external PCB circuit and the electronic paper display.

The Silicone, which is disposed in a lower bezel area of the TFT substrate to protect the wiring, the IC, and the FPC all of which are disposed on the TFT substrate.

The LED Light, which is connected to the metal pad on the front side of the TFT substrate. The metal pad is located in an area within a front bonding zone of the TFT substrate and outside the IC and the FPC, the metal pads on the TFT substrate are in one-to-one correspondence with the pads on the LED light, and the LED light is connected to one or any combination of the IC, the FPC and the PCB through a metal wiring on the TFT substrate, thereby realizing the driving and control of the LED light. As illustrated in FIGS. 3 and 4, when an LED light is disposed in an area on a right side of the TFT bonding zone, the PCB can be recessed inward to the edge of the TFT or within its footprint since it is no longer constrained by the LED light.

In an embodiment, the LED light is a flip-chip LED light with the pad located at the bottom thereof, which enables the LED light to emit light outward upward and be connected to the TFT substrate downward.

In an embodiment, the LED light is connected to the metal pad on the front side of the TFT substrate by means of any one selected from silver paste connecting, anisotropic conductive film (ACF) bonding, solder paste reflow soldering, laser welding, and eutectic bonding.

In an embodiment, the metal pad is composed of a plurality of metal film layers, which are interconnected through via-holes formed in a dielectric layer.

For example, the metal pad on the TFT substrate for bonding the LED light is composed of one or more of the metal film layers selected from Gate, SD, and ITO. The metal layers are interconnected through via-holes formed in the dielectric layer, and the topmost metal layer is located on the outermost layer of the TFT substrate, with no dielectric layer allowed to be disposed on the topmost metal layer.

If the LED light selected in the product design is a packaged LED light, an optimized connection between the LED light and the TFT substrate may be, for example, a silver paste connecting. If the LED light selected in the product design is an unpackaged LED light chip, the optional connection between the LED light and the TFT substrate may be, for example, ACF bonding. After the LED light is connected to the metal pad on the TFT substrate through a material such as a silver paste, an ACF gel, or a solder paste, it is only necessary to arrange the appropriate metal wiring on the TFT substrate to realize the interconnection between the LED light and the IC, the FPC, or the PCB, thereby achieving the driving and the control of the LED light by the IC, the FPC, or the PCB.

FIG. 5 illustrates an implementation of the electronic paper display according to an embodiment of the present disclosure. As illustrated in FIG. 5, another longitudinal cross-section view of the electronic paper display in FIG. 3 in the LED light area is provided. Since the longitudinal structure of the electronic paper display in the non-LED light area is the same as that in (a) of FIG. 4, it will not be described repeatedly. The difference between FIG. 5 and (b) of FIG. 4 mainly lies in the design of the optical structure of the LED light area:

Specifically, for example, a reflective adhesive is disposed around the LED light, with a reflectivity of at least 90%, and is configured to effectively reflect the light emitted from a lateral side of the LED light, thereby enhancing a light output intensity of the LED light. The reflective adhesive may include resin and reflective components, and the resin may be cured at room temperature, or subjected to thermal curing or UV light curing. The reflective component may be titanium dioxide or other substances with high reflectivity.

For another example, a collimating lens is disposed directly above the LED light and the reflective adhesive, which can improve the collimation of light, thereby reducing a light-emitting angle of the LED light. The collimating lens is made of transparent resin, and the collimating lens forms a hemispherical lens structure through a dispensing process.

For still another example, a light-mixing structure is disposed on a cover plate above the collimating lens and at a position corresponding to the LED light, so as to achieve uniform light output intensity, and uniform light mixing between different colors. The light-mixing structure can adopt a light diffusing film or a structure with an uneven surface.

In the embodiments of the present disclosure, by applying the reflective adhesive around the LED light and disposing the collimating lens directly above the LED light and the reflective adhesive, the light transmittance of the LED light is improved, the luminance of the LED light after the electronic paper display module is assembled into a complete device is increased, and the LED light in the electronic paper display for the electronic shelf label displays more brightly.

In an embodiment, the electronic paper display may further include an electronic paper film front plane laminate (FPL), a protective sheet (PS), Ag paste dots, an edge sealant, etc., as illustrated in FIGS. 3 and 4.

The FPL: used to display an image actually seen by human eyes; the FPL is attached and connected to an area on the front side of the TFT substrate and outside the LED light, the IC, and the FPC; an electric field is formed between a pixel electrode on the TFT substrate and a common electrode (VCOM ITO) on the FPL (where VCOM refers to a common electrode, ITO refers to a transparent conductive metal made of indium tin oxide, and VCOM ITO refers to a common electrode formed by the transparent conductive metal) to drive electronic ink in the FPL to display an image.

The Ag paste dots: disposed between the TFT substrate and the FPL; the VCOM electrode on the TFT substrate and the common electrode VCOM ITO on the FPL are connected through the Ag paste; and the main component of the Ag paste dots is a conductive silver paste.

The PS: attached to an area on the FPL and outside the LED light, the IC, and the FPC; the PS has a larger size than the FPL, with edges wrapping around the FPL; the PS is an optical and moisture barrier film used to protect the FPL and isolate moisture.

The edge sealant: coated on peripheral edges of the PS to fill a gap between the PS and the TFT, so as to further isolate moisture.

In this embodiment, a sum of the thicknesses of the FPL and the PS is not less than a height of the light-mixing structure.

With reference to FIG. 4, the thickness of the FPL is set as a, the thickness of the PS is set as b, and the thickness of the LED light is set as c. To ensure that an upper surface of the LED light does not protrude above the PS, optionally, the thickness of the LED light should be less than a sum of the thicknesses of the FPL and the PS, i.e., c≤a+b.

In existing products, the sum of the thicknesses of the FPL and the PS ranges from 0.2 to 0.5, i.e., 0.2≤a+b≤0.5. In consideration of this situation, in an embodiment, the LED light should also be selected to have a relatively small thickness, with a flat upper surface and without a lens structure, i.e., to be a surface-mount LED light. The type of surface-mount LED light may be an unpackaged LED light chip or a packaged LED light.

In an embodiment, the packaged LED light may internally package a plurality of LED light chips, and/or, the packaged LED light internally packages an LED light driving control chip. For example, the interior of the LED light may contain a single LED light chip, or two, three, or more LED light chips. The LED light may package only the LED light chip, or both the LED light chip and the LED light driving control chip therein.

In an embodiment, the color of the LED light is one of red (R) monochromatic, green (G) monochromatic, blue (B) monochromatic, multi-color and mixed color.

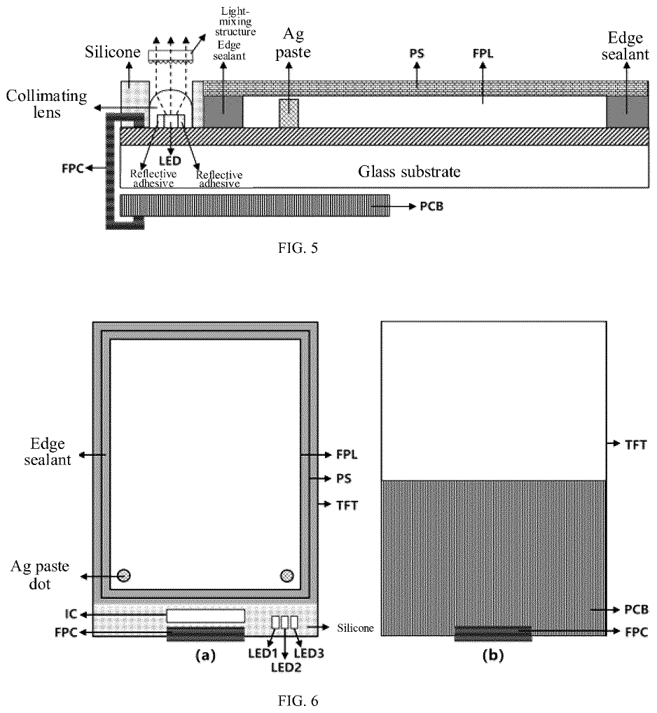

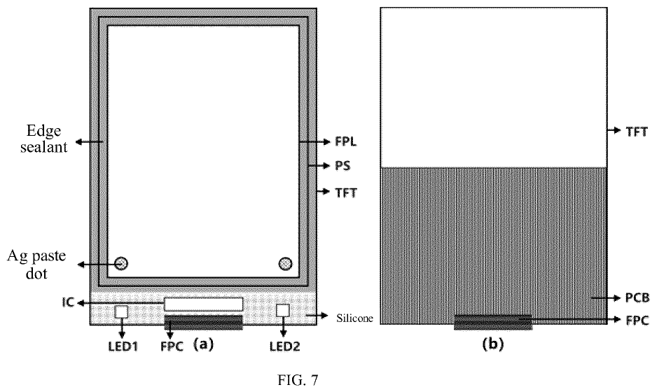

FIG. 6 illustrates an implementation of an electronic paper display according to an embodiment of the present disclosure. As illustrated in FIG. 6, a second plan view of a novel electronic paper display with an LED light disposed on a TFT substrate is provided: (a) of FIG. 6 is a front plan view, where a TFT substrate is on top and a PCB is at bottom; and (b) of FIG. 6 is a rear plan view, where a PCB is on top and a TFT substrate is at bottom.

As illustrated in FIG. 6, the LED light is disposed on the TFT substrate; specifically, the LED light is disposed in an area within a TFT bonding zone and outside the IC and FPC. In this example, for the convenience of explanation, three LED lights are disposed in an area on a right side of the TFT bonding zone. Since no longer constrained by the LED light, the PCB can be recessed inward to the edge of the TFT or within its footprint.

The longitudinal cross-sectional view of the electronic paper display, the requirement of the thickness of the LED light, the type of the LED light, the mode of connection between the LED light and the TFT substrate, the mode of driving the LED light, etc. are similar to those in the above embodiments, and will not be described in detail here.

FIG. 7 illustrates an implementation of an electronic paper display according to an embodiment of the present disclosure. As illustrated in FIG. 7, a third plan view of a novel electronic paper display with an LED light disposed on a TFT substrate is provided: (a) of FIG. 7 is a front plan view, where a TFT substrate is on top and a PCB is at bottom; and (b) of FIG. 7 is a rear plan view, where a PCB is on top and a TFT substrate is at bottom.

As illustrated in FIG. 7, the LED light is disposed on the TFT substrate; specifically, the LED light is disposed in an area within a TFT bonding zone and outside the IC and FPC. In this example, for the convenience of explanation, one LED light is disposed in an area on a left side of the TFT bonding zone, and the other LED light is disposed in an area on a right side of the TFT bonding zone. Since no longer constrained by the LED light, the PCB can be recessed inward to the edge of the TFT or within its footprint.

The longitudinal cross-sectional view of the electronic paper display, the requirement of the thickness of the LED light, the type of the LED light, the mode of connection between the LED light and the TFT substrate, the mode of driving the LED light, etc. are similar to those in the above embodiments, and will not be described in detail here.

To sum up, by disposing one, two, or more LED lights in the bonding zone of the TFT substrate, a narrow bezel and a low cost can be achieved for the electronic paper display for the electronic shelf label. The above design solutions are not only applicable to a module structure of FPC plus PCB but also to other types of electronic paper display modules such as a single FPC, Chip-On-Film (COF) plus PCB, etc., which will not be described in detail here.

In the embodiments of the present disclosure, by disposing the metal pad for bonding the LED light in the bonding zone on the TFT substrate, and bonding the LED light on the TFT substrate, it is possible to eliminate the constraints of the LED light on the PCB, and flexibly set the size of the PCB based on requirements of actual applications, thereby achieving the narrow bezel and the low cost for the electronic paper display for the electronic shelf label.

The above specific embodiments make further detailed explanations to the objectives, technical solutions and advantageous effects of the present disclosure. It should be understood that those described above are only specific embodiments of the present disclosure and are not intended to limit the protection scope of the present disclosure. Any modification, equivalent substitution or improvement made within the spirit and principle of the present disclosure should fall within the protection scope of the present disclosure.

What is claimed is:

1. An electronic paper display, for use in a display screen of an electronic shelf label, the electronic paper display comprising: a control printed circuit board (PCB), a thin film transistor (TFT) substrate, a flexible printed circuit (FPC) board, an integrated circuit (IC) and a Light Emitting Diode (LED) light;
wherein the PCB is located on a back side of the TFT substrate, and the FPC connects the PCB and the TFT substrate;
the IC is connected on the front side of the TFT substrate in a non-display area; and
the LED light is connected to a metal pad on the front side of the TFT substrate, the metal pad is located in an area within a front bonding zone of the TFT substrate and outside the IC and the FPC, and the LED light is connected to one or any combination of the IC, the FPC and the PCB through a metal wiring on the TFT substrate.

2. The electronic paper display according to claim 1, wherein the LED light is a flip-chip LED light with the pad located at the bottom thereof.

3. The electronic paper display according to claim 1, wherein the LED light is connected to the metal pad on the front side of the TFT substrate by means of any one selected from silver paste connecting, anisotropic conductive film (ACF) bonding, solder paste reflow soldering, laser welding, and eutectic bonding.

4. The electronic paper display according to claim 1, wherein the metal pad is composed of a plurality of metal film layers, which are interconnected through via-holes formed in a dielectric layer.

5. The electronic paper display according to claim 1, wherein a reflective adhesive is disposed around the LED light, a collimating lens is disposed directly above the LED light and the reflective adhesive, and a light-mixing structure is disposed on a cover plate at a position corresponding to the LED light, wherein the cover plate is disposed above the collimating lens.

6. The electronic paper display according to claim 5, wherein the collimating lens is made of transparent resin, and the collimating lens forms a hemispherical lens structure through a dispensing process.

7. The electronic paper display according to claim 5, wherein the light-mixing structure employs a light diffusing film, or a structure with an uneven surface.

8. The electronic paper display according to claim 5, wherein the reflective adhesive comprises resin and a reflective component.

9. The electronic paper display according to claim 5, further comprising an electronic paper film front plane laminate (FPL) and a protective sheet (PS), wherein a sum of the thicknesses of the FPL and the PS is not less than a height of the light-mixing structure; the FPL is attached and connected to an area on the front side of the TFT substrate and outside the LED light, the IC, and the FPC; an electric field is formed between a pixel electrode on the TFT substrate and a common electrode (VCOM ITO) on the FPL to drive electronic ink in the FPL to display an image; the PS is attached to an area on the FPL and outside the LED light, the IC, and the FPC, and the PS has a larger size than the FPL, with edges wrapping around the FPL.

10. The electronic paper display according to claim 9, wherein the LED light is a surface-mount LED light with a flat upper surface and without a lens structure.

11. The electronic paper display according to claim 10, wherein the surface-mount LED light is an unpackaged LED light chip or a packaged LED light.

12. The electronic paper display according to claim 11, wherein the packaged LED light internally packages a plurality of LED light chips, and/or, the packaged LED light internally packages an LED light driving control chip.

13. The electronic paper display according to claim 1, wherein the color of the LED light is one of red (R) monochromatic, green (G) monochromatic, blue (B) monochromatic, multi-color and mixed color.

14. The electronic paper display according to claim 1, wherein the size of the PCB is less than or equal to that of the TFT substrate.
